(19) United States
(12) Patent Application Publication
(10) Pub. No.: US 2005/0224288 A1
(43) Pub. Date: Oct. 13, 2005

(54) Wildlife observation stand

(76) Inventors: Curtis J. Chesness, Andover, MN (US); Thomas J. Chesness, Ramsey, MN (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/104,971

(22) Filed: Apr. 12, 2005

Related U.S. Application Data
(60) Provisional application No. 60/561,794, filed on Apr. 13, 2004.

(51) Int. Cl. A01M 31/00

(52) U.S. Cl. 182/115

(57) ABSTRACT

The present invention is a wildlife observation stand capable of being rollably transportable along a surface. The stand comprises a perch, a base, and a handle. The perch includes a sidewall and a platform structure. The platform structure has a circular outer circumference and an axle centered in said platform. The circular outer circumference defines a volume. The base is adapted to support the perch. The handle is adapted to connect to the axle. The base and sidewall may be dismantled and contained within the volume and the platform structure may be used as a wheel that pivots about said axle in order to rollably transport the stand.

### CROSS-REFERENCE TO RELATED APPLICATION

The present patent application claims priority from U.S. Provisional Patent Application No. 60/561,794, which was filed Apr. 13, 2004. The present patent application incorporates by reference the contents of said provisional patent application in its entirety.

### FIELD OF THE INVENTION

The present invention relates to platforms and methods of assembling and transporting platforms. More specifically, the present invention relates to wildlife observation stands and methods of assembling and transporting such stands.

### BACKGROUND OF THE INVENTION

Wildlife conservationists and enthusiasts, e.g., hunters and bird watchers, utilize tower-like platforms or stands to observe animals from an elevated position. In the past, wildlife enthusiasts utilized permanent stands that were set up and left in place year round.

Laws have changed in many jurisdictions and, as a result, stands must not be left permanently in place. Permanent stands are time consuming to assemble and very heavy to transport, typically requiring the use of a vehicle. Consequently, a high demand for portable stands has developed.

Current portable stands are still quite heavy, typically requiring an ATV or two people for transport. Furthermore, the stands are still time consuming to assemble. Laws in many jurisdictions now prevent the use of an ATV in wilderness areas and require that a stand be taken down after every use (e.g., hunt).

There is a need in the art for a portable wildlife observation stand that is easily transported and assembled by a single person. Furthermore, there is a need in the art for a method of easily transporting and assembling a portable wildlife observation stand.

### BRIEF SUMMARY OF THE INVENTION

The present invention, in one embodiment, is a wildlife observation stand capable of being rollably transportable along a surface. The stand comprises a perch, a base, and a handle. The perch includes a sidewall and a platform structure. The platform structure has a circular outer circumference and an axle centered in said platform. The circular outer circumference defines a volume. The base is adapted to support the perch. The handle is adapted to connect to the axle. The base and sidewall may be dismantled and contained within the volume and the platform structure may be used as a wheel that pivots about said axle.

The present invention, in another embodiment, is a base system for supporting the perch of a wildlife observation stand above a surface. The base comprises a leg and a strap. The leg includes a first end adapted for connection to the perch, a second end adapted to abut against the surface, a first hook receiving structure near the first end, a second hook receiving structure near the second end, and a member having a free end and a pivot end pivotally attached to the leg approximately midway between the first and second hook receiving structures. The strap includes a first end with a first hook adapted to engage the first structure, a second end with a second hook adapted to engage the second structure, and a means for removing the slack from said strap. The strap and leg form a truss-like arrangement when the first hook engages the first structure, the second hook engages the second structure, the slack is removed from the strap, and the member is pivoted into a position where the member is generally perpendicular to the leg and the free end engages the strap.

The present invention, in another embodiment, is a wildlife observation stand. The stand comprises a perch and a base adapted to support the perch when the stand is in an erected state. The perch comprises a platform that has a circular outer circumference. The platform is configured to be rollably displaceable while supporting at least one element of the stand when the stand is in a non-erected state.

In one embodiment, the circular outer circumference defines a volume and at least one element of the stand is supported within the volume. The stand also includes an axle centered in the platform and about which the platform pivots when being rollably displaced.

In one embodiment, a handle is adapted to connect to the axle. The handle converts to a seat pivotably coupled to the platform when the stand is in an erected state. The perch includes a sidewall.

The present invention, in another embodiment, is a wildlife observation stand comprising a platform and a base adapted to support the platform. The stand is rollably displaceable in a non-erected state.

In one embodiment, the platform comprises an axle for rollable displacement of the stand. In one embodiment, the stand includes a handle pivotably coupled to the axle. In one embodiment, the handle is configured to become a seat coupled to the platform. In one embodiment, the stand includes a wheel pivotably coupled to the stand.

In one embodiment, the platform further comprises a volume for holding elements of the stand when the stand rollably displaces. In one embodiment, the elements include portions of the base.

The present invention, in another embodiment, is a base system for supporting the perch of a wildlife observation stand above a surface. The base comprises a leg and a cable-like element (e.g., a cable, rope, strap, wire, chain, etc. that is capable of resisting tension forces, but unable to resist compressive forces). The leg includes a first end adapted for connection to the perch, a second end adapted to abut against the surface, and a member having a free end opposite a pivot end pivotally attached to the leg between the first and second ends. The cable-like element includes a first end operably coupled to the leg near the first end and a second end operably coupled to the leg near the second end.

In one embodiment, the cable-like element and leg form a truss-like arrangement when the member is pivoted into a position where the member is not parallel to the leg and the free end engages the cable-like element. In one embodiment, the cable-like element is a cable. In one embodiment, the member includes a pulley at the free end for receiving the cable. In one embodiment, the cable-like element is a strap.

The present invention, in another embodiment, is a method of transporting a wildlife observation stand. The method includes storing at least one element of the stand within a stand platform and rollably displacing the platform along a surface. In one embodiment, the stand platform includes an axle pivotably coupled to a handle. In one embodiment, the stand platform includes an axle pivotably coupled to a wheel.

While multiple embodiments are disclosed, still other embodiments of the present invention will become apparent to those skilled in the art from the following Detailed Description, which shows and describes illustrative embodiments of the invention. As will be realized, the invention is capable of modifications in various obvious aspects, all without departing from the spirit and scope of the present invention. Accordingly, the drawings and Detailed Description are to be regarded as illustrative in nature and not restrictive.

### BRIEF DESCRIPTION OF THE DRAWINGS

FIG. 1 is a side elevation view of the wildlife observation stand in its fully deployed configuration.

FIG. 2a is a side elevation view of the wildlife observation stand in its fully deployed configuration.

FIG. 2b is a side elevation view of an alternative embodiment of the observation stand in its fully deployed configuration.

FIG. 3a is a side elevation view of the wildlife observation stand in its transportation configuration with the handle connected to a snowmobile.

FIG. 3b is an enlarged side elevation view of the wildlife observation stand in its transportation configuration.

FIG. 3c is a side elevation view of the wildlife observation stand in its transportation configuration being rolled over an obstacle (e.g., a log) by a single person griping the handle.

FIG. 4a is a side elevation view of the wildlife observation stand in its fully deployed configuration.

FIG. 4b is an isometric view of the sidewall frame fully extended from the perch.

FIG. 4c is an isometric view of the bottom end of the lower vertical member.

FIG. 4d is an isometric view of the sidewall frame wherein the upper vertical members are fully retracted within the lower vertical members.

FIG. 4e is an isometric view of the sidewall frame being rotated to cause the lower vertical members to lay down within the framework of the perch.

FIG. 4f is an isometric view of the sidewall frame fully nestled within the framework of the perch.

FIG. 4g is an isometric view of the bottom of the perch with the sidewall frame fully extended and the fabric sidewall pulled down and cinched tight about the bottom edge of the perch via a drawstring.

FIG. 5 is a bottom view of the stand as viewed from directly below the stand.

FIG. 6 is an enlarged view of a platform/cable connection point and a means of securing a leg to the structure of the round platform.

FIG. 7 is an enlarged view of a leg/cable connection point.

FIG. 8a is a side elevation view of a leg illustrating the truss-type structural arrangement formed by the leg, pivotal member and a cable-like structural element such as a strap.

FIG. 8b is a side elevation view of a truss-type structural arrangement depicted in FIG. 8a, except the arrangement employs a cable.

FIG. 8c is an isometric view of the free end of the pivotal member employing a pulley for engaging the cable shown in FIG. 8c.

FIG. 8d is an isometric view of a leg height adjustment feature.

FIG. 9 is an enlarged isometric view of the pivotal member in the extended position.

FIG. 10 is a bottom view of the platform with the fabric sidewall secured to the circumference of the platform.

FIG. 11 is a bottom view of the platform illustrating its structural arrangement.

FIG. 12 is an isometric view of the platform illustrating its structural arrangement.

FIG. 13 is a side elevation view of the platform illustrating is structural arrangement.

FIG. 14a is a bottom side view of the platform is its transportation configuration and illustrating its ability to be moved by a single person.

FIG. 14b is a bottom side view of the platform showing one means of securing the leg segments and cables of the base within volume of the platform.

FIG. 15a is a plan view of the handle.

FIG. 15b is side view of another embodiment of the handle connected to the stand in its transportation configuration, the handle including a seat portion and a back portion for forming a chair.

FIG. 15c is an isometric view of the handle being converted into the seat.

FIG. 15d is an isometric view of the handle converted into the seat and installed within the perch.

FIG. 15e is a plan view of an embodiment of the handle including a pivotable hitch for connecting to an ATV or snowmobile.

FIG. 16 is view of a chair and an opening of a pouch within the perch.

FIG. 17 is view of the pouch from outside of the perch.

FIG. 18 is an elevation of the stand employing a base with a scaffold-type bracing arrangement.

FIG. 19 is an elevation of the stand employing a base with a scaffold-type bracing arrangement.

FIG. 20 is an elevation of the stand employing a base with a scissors-type leg arrangement.

FIG. 21 is an elevation of the stand employing a base with a pivotable, telescoping leg arrangement.

FIG. 22a is a side elevation of the stand having a round platform and in the transportation configuration.

FIG. 22b is a front elevation of the stand having a round platform and in the transportation configuration.

FIG. 23a is a side elevation of the stand having a rectangular platform and in the transportation configuration.

FIG. 23b is a front elevation of the stand having a rectangular platform and in the transportation configuration.

### DETAILED DESCRIPTION

The present invention is a novel and advantageous wildlife observation stand that may be easily moved and deployed by an individual person. This is made possible for at least two reasons. First, the stand's novel structural design allows the stand to be lightweight, yet strong and sturdy when the stand is in its fully deployed configuration. Second, the stand's novel configuration allows the stand to transform into a large wheel that may be easily rolled along by an individual person when the stand is in its transportation configuration. These and other novel and advantageous aspects of the stand will become apparent from the following detailed description of the stand.

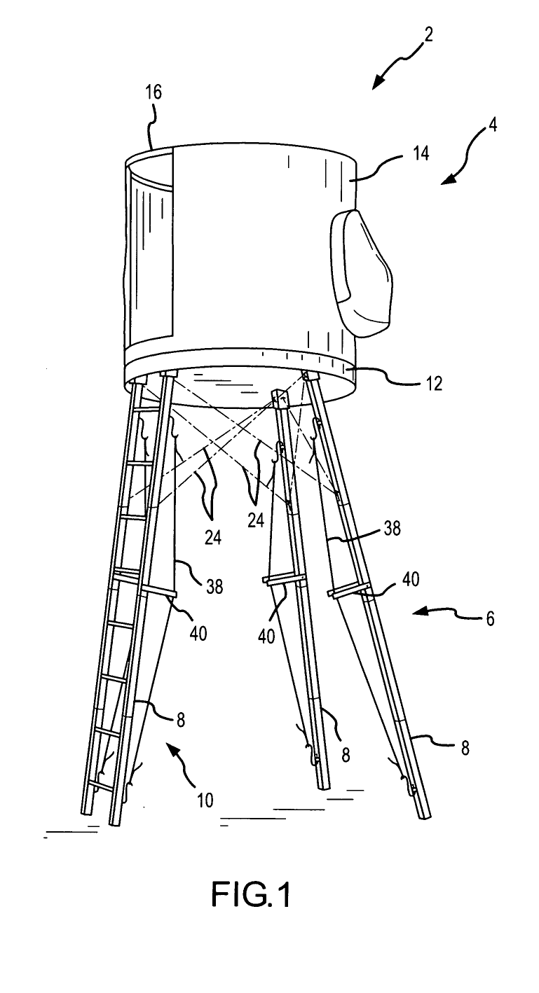

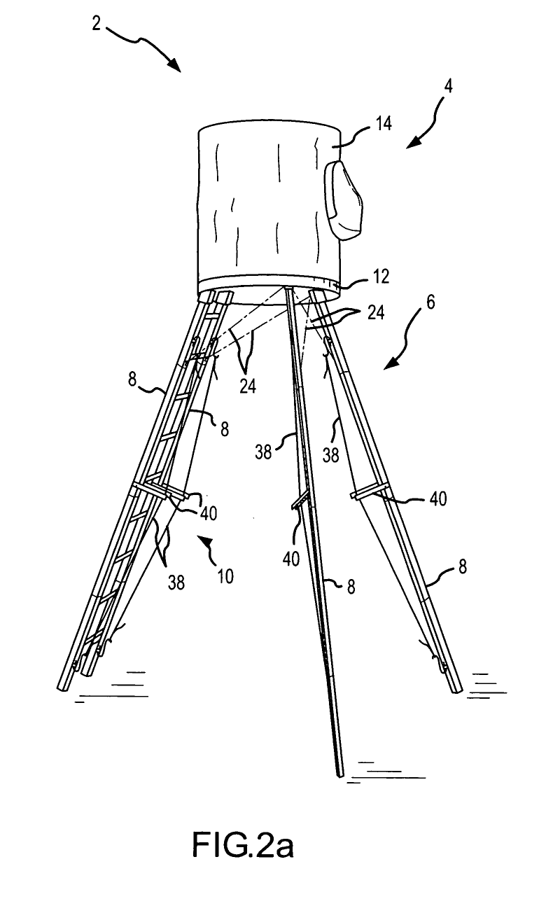

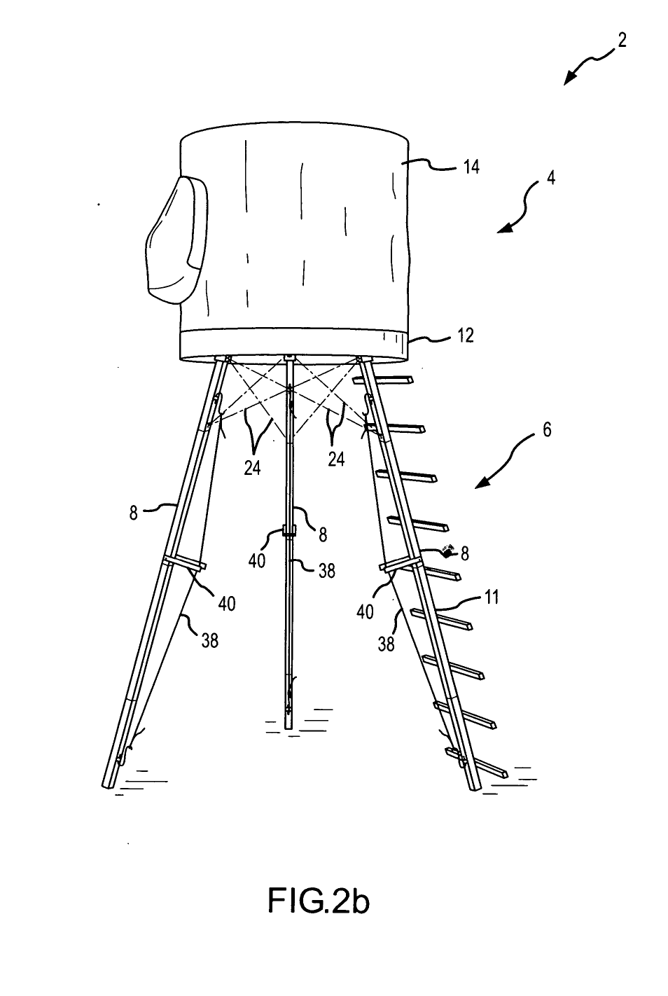

FIGS. 1, 2a and 2b are side elevation views of the wildlife observation stand 2 in its fully deployed configuration (i.e., the stand 2 is in an erected state). As indicated in FIGS. 1, 2a and 2b, the stand 2 includes a perch 4 and a base 6. In one embodiment, as depicted in FIGS. 1 and 2a, the base 6 includes four legs 8, two of which server as rails for a ladder 10. In one embodiment, as illustrated in FIG. 2b, the base includes three legs 8, one of which serves as a ladder pole 11. The perch 4 includes a round platform 12 and a fabric sidewall 14 supported off of the platform 12 by a sidewall frame 16.

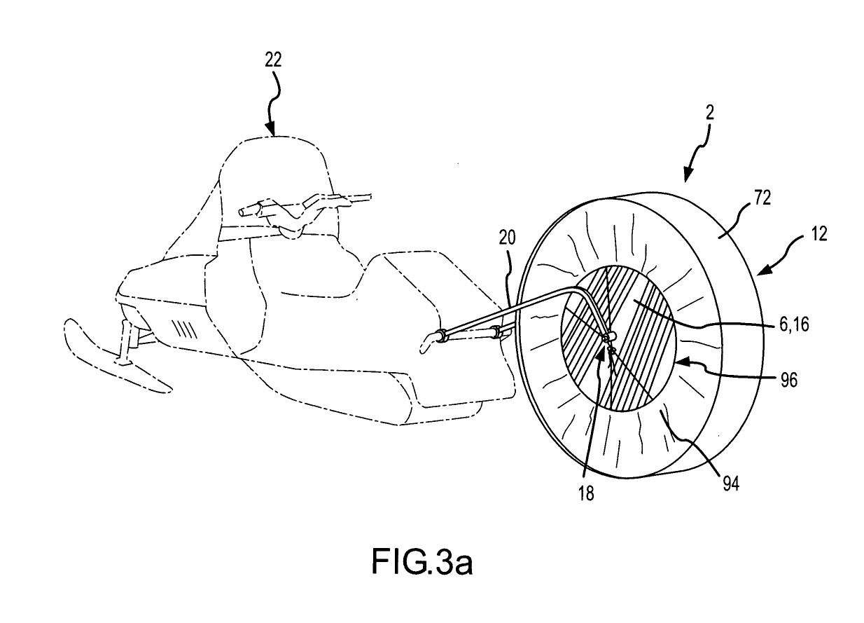

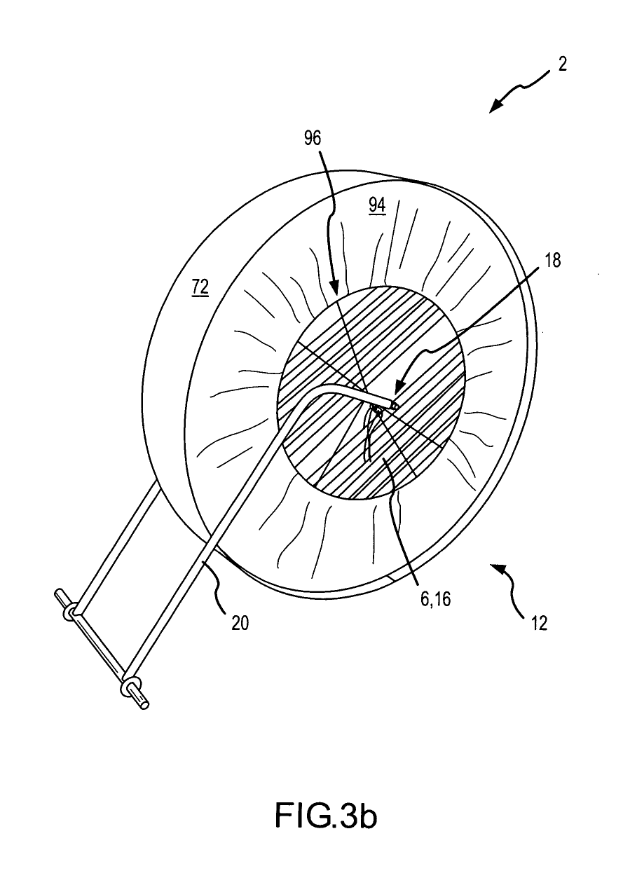

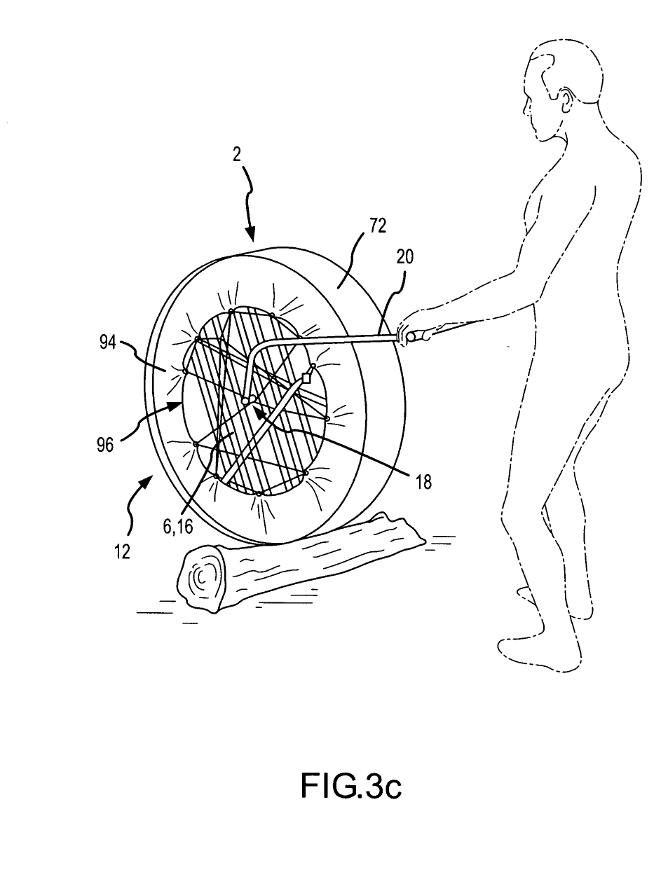

FIGS. 3a, 3b and 3c are side elevation views of the stand 2 in its transportation configuration (i.e., the stand 2 is in a non-erected state and prepared for rollable displacement). As shown in FIG. 3b and as will be further explained later in this Detailed Description, the parts comprising the base 6, the sidewall frame 16 and other aspects of the stand 2 are dismantled and secured within the round platform 12, which has an axle 18 with a handle 20 connected thereto. As indicated in FIG. 3a, the handle 20 may be attached to vehicles (e.g., a snowmobile 22, an ATV, an SUV, etc.) for towing the stand 2 when it is in the transportation configuration. Alternatively, a person (as depicted in FIG. 3c) may simply grab the handle 20 and push or pull the stand 2 when it is in the transportation configuration.

As can already be understood from FIGS. 1, 2, 3a, 3b and 3c, the stand 2 is advantageous for several reasons. First, as indicated in FIGS. 1 and 2, the stand 2 benefits from a lightweight base 6 that is strong and sturdy. This facilitates its assembly by a single person. Second, as indicated in FIGS. 3a, 3b and 3c, the stand 2 transforms into a large wheel when placed in its transportation configuration. This feature coupled with its lightweight allows the stand 2 to be easily transported by an individual person without the use of a vehicle.

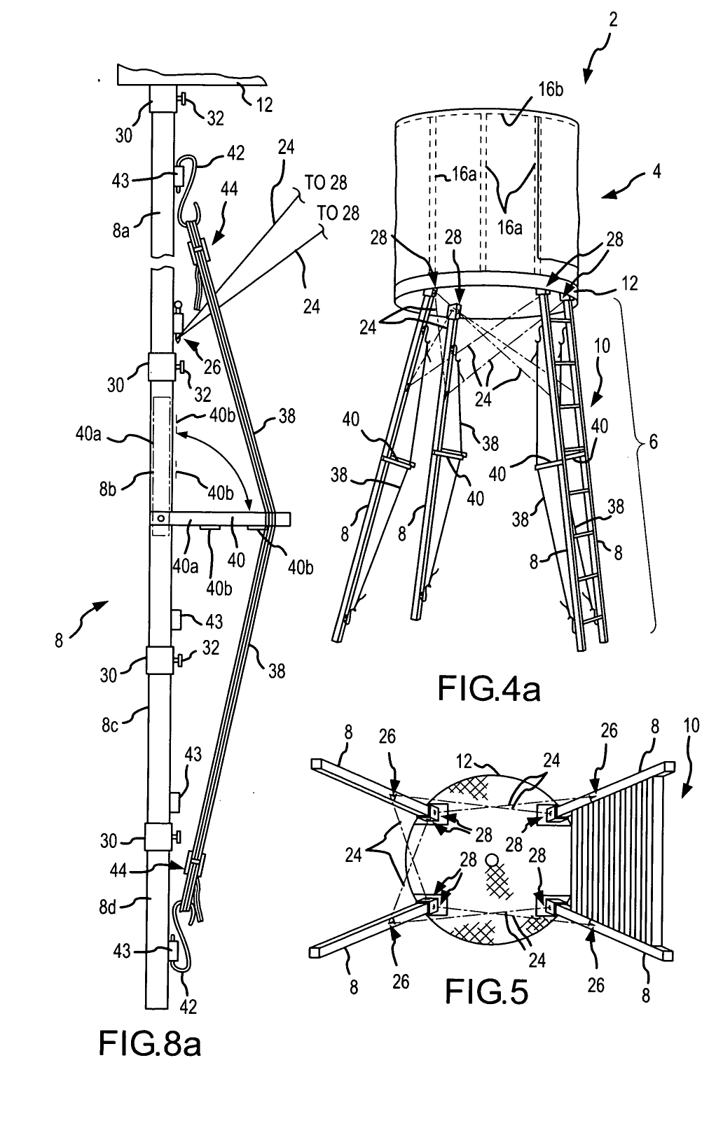

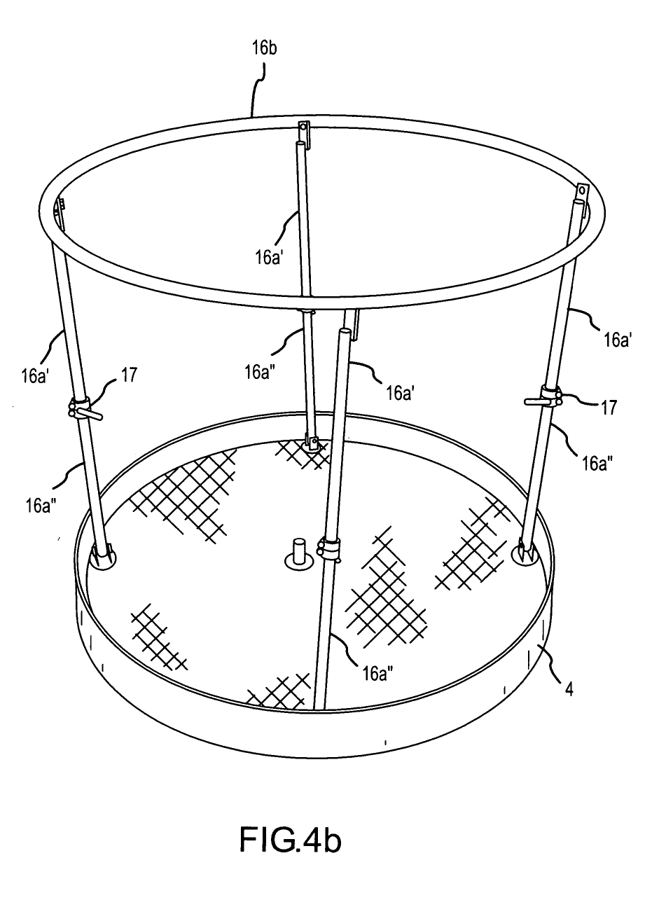

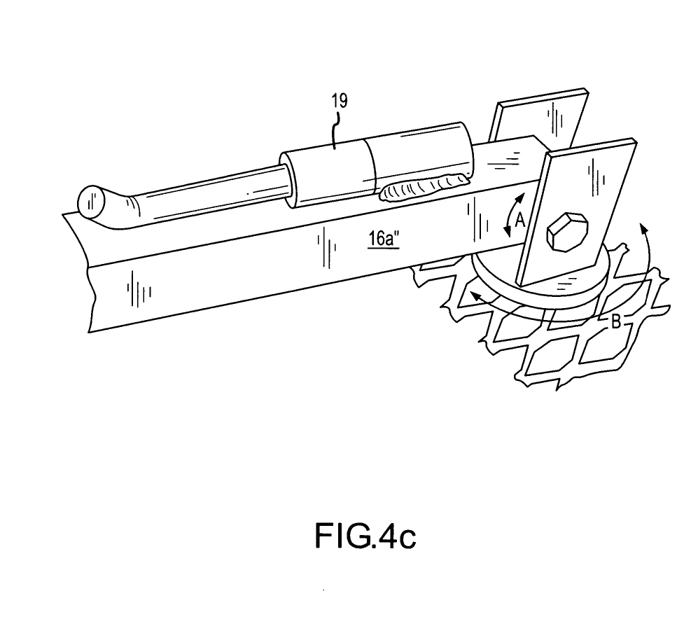

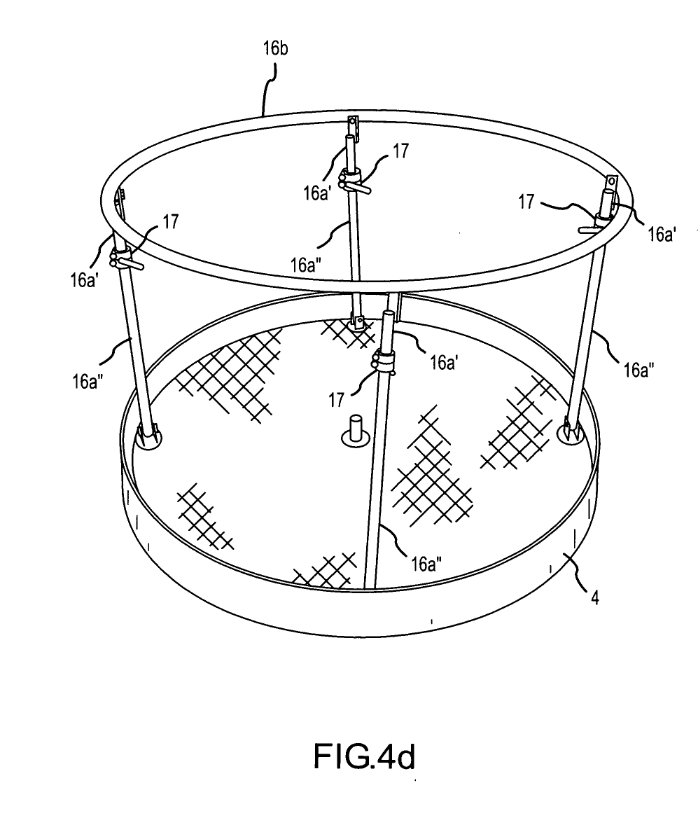

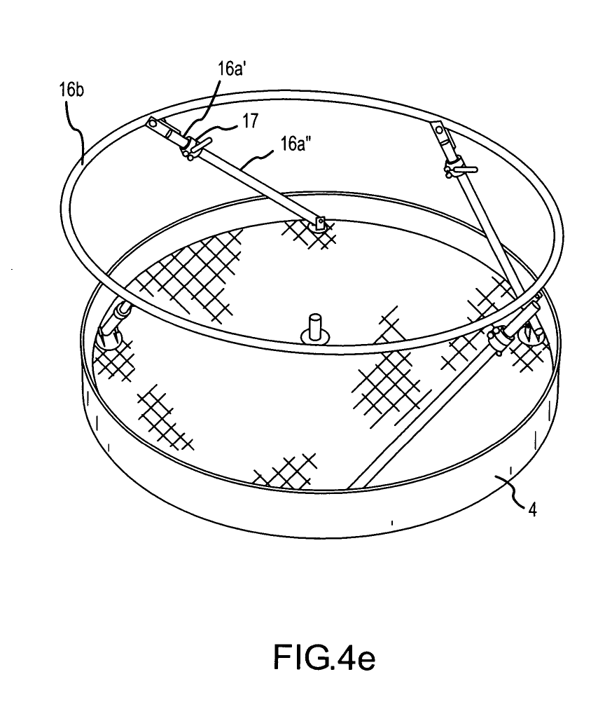

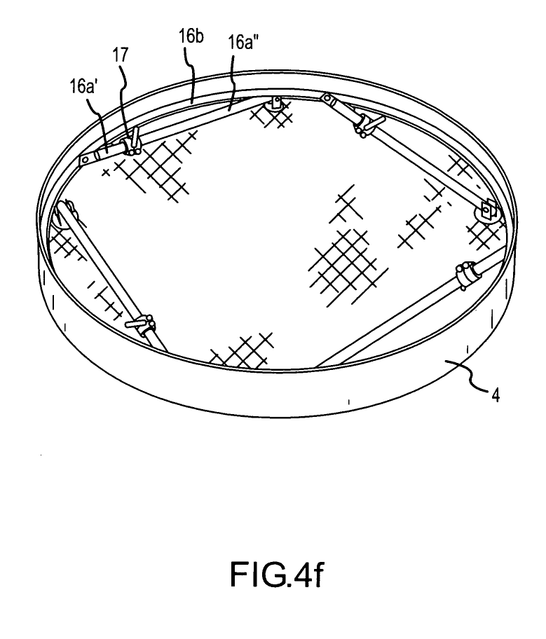

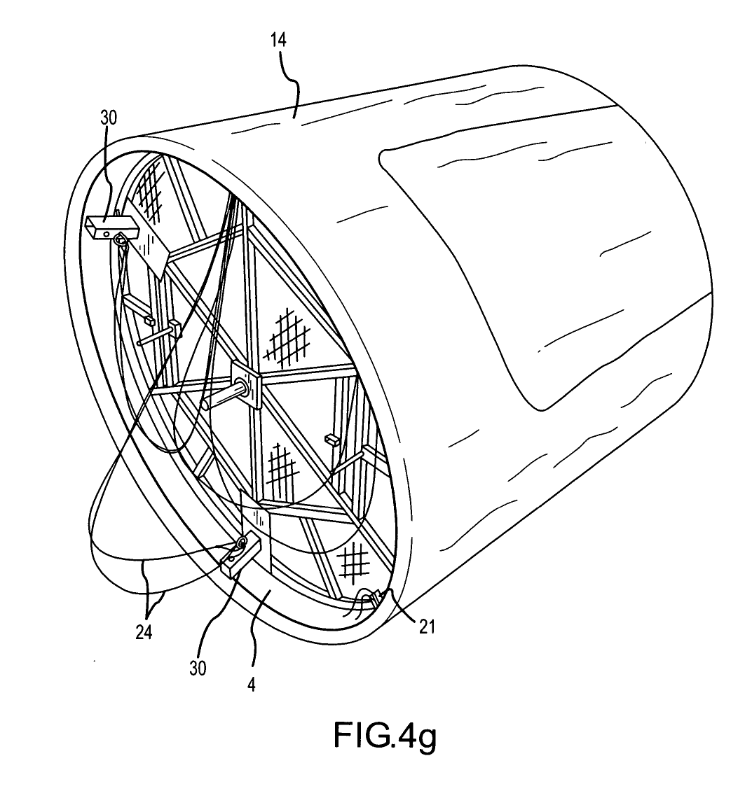

For a discussion of the structural arrangement of the base 6 and the perch 4, reference is now made to FIGS. 4a and 5. FIG. 4a is a side elevation view of the wildlife observation stand 2 in its fully deployed configuration. FIG. 5 is a bottom view of the stand 2 as viewed from directly below the stand 2.

As illustrated in FIG. 4a, the sidewall frame 16 of the perch 4 is comprised of vertical members 16a and a horizontal hoop 16b. The hoop 16b provides the structural support for the upper edge of the sidewall 14. The vertical members 16a are received within holes in the round platform 12 and extend upwards to support the hoop 16b, thereby providing support for the fabric sidewall 14 of the perch 4. In one embodiment, the vertical members 16a and horizontal hoop 16b are ⅝″, 18 gage round aluminum tubing. In other embodiments, the members 16a, and hoop 16b are steel tubing, fiberglass rods, or made of polymer or polymer/composite materials. In one embodiment, the fabric sidewall 14 is 39″ tall and is canvas or a synthetic, such as nylon.

For a detailed discussion of an embodiment of the sidewall frame 16, wherein the sidewall frame 16 is collapsible and storable within the framework of the perch, reference is now made to FIGS. 4a-4f. FIG. 4b is an isometric view of the sidewall frame 16 fully extended from the perch 4. As indicated in FIG. 4b, a plurality of vertical members 16a extend from the perch 4 to support the horizontal loop 16b. Each vertical member 16a has an upper vertical member 16a′ telescopically residing within a lower vertical member 16a″. In one embodiment, the upper vertical member 16a′ is ⅝″ diameter tube, and the lower vertical member 16a″ is a 20″ long ¾″ diameter tube. In one embodiment, the tube is metal. In another embodiment, the tube is a polymer material.

As shown in FIG. 4b, each vertical member 16a includes a clamping mechanism 17 near the upper end of each lower vertical member 16a″. Each clamping mechanism 17 can be tightened to maintain its respective upper vertical member 16a′ fixedly extended. As a result of the telescopic configuration of each vertical member 16a and its respective clamping mechanism 17, the horizontal loop 16b is selectively positional with respect to height.

As illustrated in FIG. 4b, the top end of each upper vertical member 16a′ is pivotally connected to the horizontal loop 16b, and the bottom end of each lower vertical member 16a″ is pivotally connected to the perch 4.

As depicted in FIG. 4c, which is an isometric view of the bottom end of the lower vertical member 16a″, said bottom end is horizontally pivotal (as indicated by arrow A) and vertically pivotal (as indicated by arrow B). The bottom end of each lower vertical member 16a″ includes a pin mechanism 19 for securing the lower vertical member 16a″ in an upright position.

As indicated in FIG. 4d to begin collapsing the sidewall frame 16 into the perch 4, the clamp mechanism 17 for each vertical member 16a is released and each upper vertical member 16a′ is allowed to telescopically slide into its respective lower vertical member 16a″. The sidewall frame 16 now appears as indicated in FIG. 4d.

As shown in FIG. 4e, the horizontal hoop 16b is rotated such that each lower vertical member 16a″ pivots both horizontally and vertically at its bottom end where is couples to the perch 4. As a result, the horizontal hoop 16b vertically lowers as each lower vertical member 16a″ pivots inwardly and downwardly to appear as depicted in FIG. 4f, wherein the sidewall frame 16 is completely collapsed and stored within the framework of the perch 4.

For clarity, FIGS. 4b-4f show the sidewall frame 16 without the fabric sidewall 14. However, in actual use, the fabric sidewall 14 will remain attached to the horizontal hoop 16b of the sidewall frame 16 via VELCRO® straps when being extended from, or retracted into, the framework of the perch 4. Once the sidewall frame 16 is fully extended, the bottom of the fabric sidewall 14 is pulled down about the bottom rim edge of the perch 4 and cinched tight via a draw string 21 to appear as shown in FIG. 4g.

As shown in FIGS. 4a and 5, cables 24 run from a leg/cable connection point 26 to a platform/cable connection point 28 for each leg 8. The cables 24 keep the bottom ends of the legs 8 from displacing away from each other. In other words, the cables 24 prevent the legs 8 from sprawling flat under load. In one embodiment, the cables are ⅛″ diameter aircraft cables.

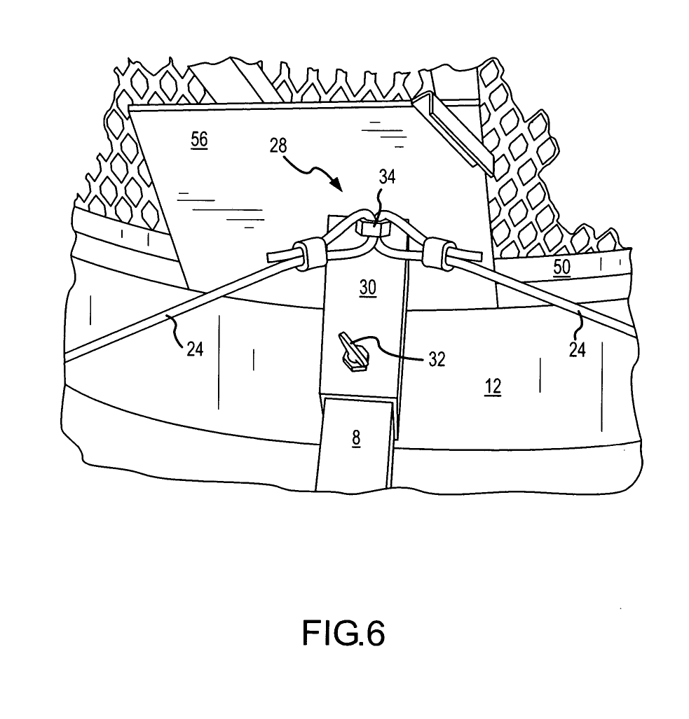

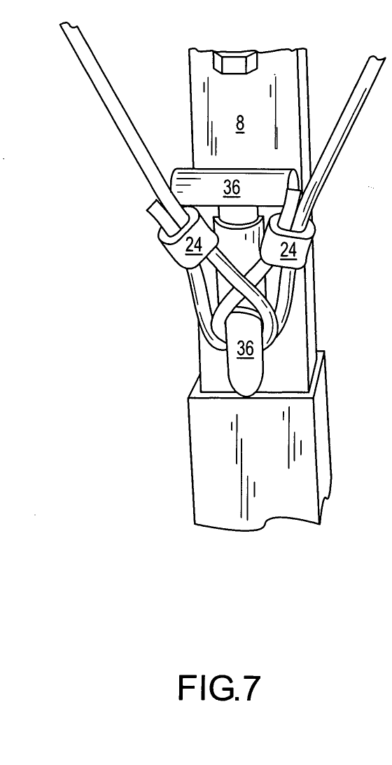

For a more detailed description of the leg/cable and platform/cable connection points 24, 26 and the means of securing a leg 8 to the structure of the round platform 12, reference is now made to FIGS. 6 and 7. FIG. 6 is an enlarged view of a platform/cable connection point 28 and a means of securing a leg 8 to the structure of the round platform 12. FIG. 7 is an enlarged view of a leg/cable connection point 26.

As indicated in FIG. 6, a coupler 30 is welded to the structure of the round platform 12. The top of a leg 8 is received within the coupler 30 and a wing nut 32 mounted on the coupler 30 may be tightened to secure the leg 8 within the coupler 30. The platform/cable connection point 28 is formed by a structural eyelet 34 welded to, or near, a coupler 30. The end of each cable 24 is looped through the eyelet 34 and secured to itself.

As shown in FIG. 7, the leg/cable connection point 26 comprises a pin 36 slidably attached to a leg 8. The bottom end of the pin 36 extends through the loop of each cable 24. To release the cables 24, the pin is lifted upwards, which causes the end of the pin 36 to be removed from within the loops of the cables 24. To secure the cables 24 to the leg 8, the loops of the cables are placed below the pin pathway and the pin 36 is lowered such that its bottom end passes through the loops of the cables to appear as indicated in FIG. 7.

As illustrated in FIG. 4a, each leg 8 is stiffened by a cable-type element 38 running across a pivotal member 40. When the pivotal member 40 is deployed into the stiffening configuration as shown in FIG. 4a, the leg 8, cable-type element 38 and pivotal member 40 combine to form a truss-type arrangement, which allows the legs to be light weight, yet strong and sturdy. For purposes of this Detailed Description and the claims, the term cable-type element 38 means a structural element such as a cable, wire, rope, strap, chain, etc. that is only capable of supporting a tension load, not a compression load.

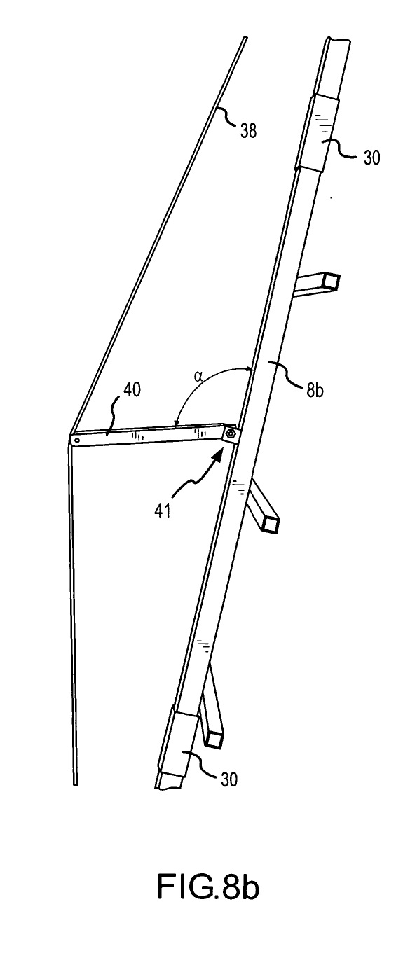

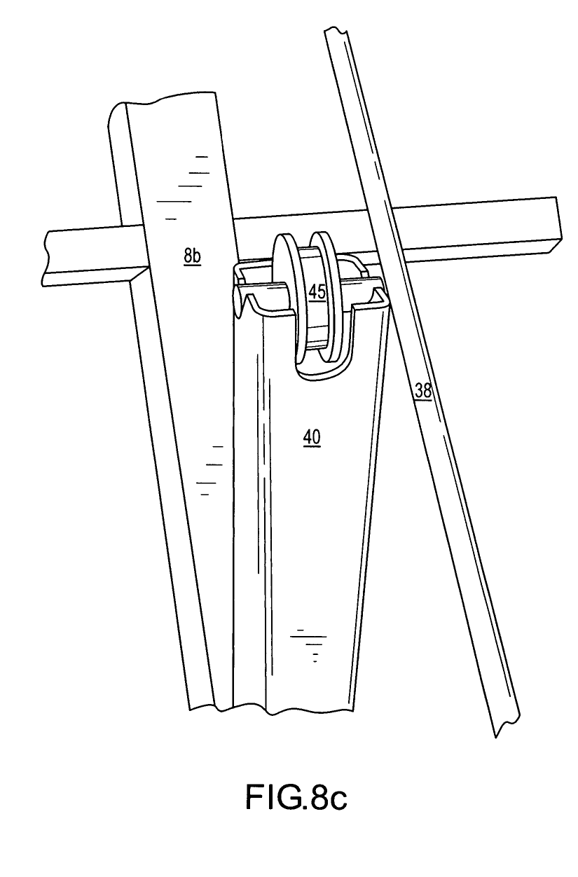

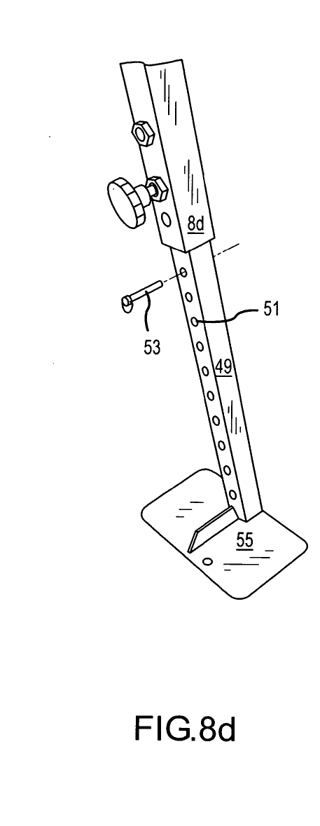

For a more detailed description of the truss-type arrangement for the legs 8, reference is made to FIG. 8a, which is a side elevation view of a leg 8 with the pivotal member deployed perpendicularly from the leg 8 to form the truss-type arrangement. As indicated in FIG. 8a, the leg 8 is segmented into multiple sections 8a, 8b, 8c, 8d to allow the legs 8 to be stored within the round platform 12 when the stand 2 is in the transportation configuration (as depicted in FIG. 3) and to allow the height of the stand 2 to be varied as desired. The top of each leg segment 8a, 8b, 8c, 8d is received within the coupler 30 of the segment immediately above. Each coupler 30 is equipped with a wing nut 32 for securing the top of the leg segment within the coupler 30. In one embodiment, each leg segment 8a, 8b, 8c, 8d is 1¼″ square, 16 gage steel tubing and the couplers 30 are 1½″ square, 12 gage steel tubing. In one embodiment, each leg segment 8a, 8b, 8c, 8d is 35 inches long and there are four sets of leg segments. In one embodiment, the leg segments are made from a metal. In another embodiment, the leg segments are made from a polymer material.

As shown in FIG. 8a, in one embodiment, the cable-type element 38 is a strap 38 that has a top and a bottom hook 42, each of which is attached to the leg 8 via a hook receiving structure 43. As indicated in FIG. 8a, each leg segment 8a, 8b, 8c, 8d has its own hook receiving structure 43. As a result, the leg segment that ends up being the lowest leg segment may receive the bottom hook 42 in its hook receiving structure 43. Thus, if the leg 8 only comprises two of the possible four leg segments 8a, 8b, 8c, 8d (i.e., the leg 8 is only two segments 8a, 8b long and the bottom leg segment is 8b), the bottom hook 42 would be received by the hook receiving structure 43 of leg segment 8b. Likewise, if the leg 8 is four segments long, the bottom hook 42 would be received by the hook receiving structure 43 of leg segment 8d.

As illustrated in FIG. 8a, the strap 38 is equipped with one or more tightening buckles 44, which allow slack to be added to, or removed from, the strap 38. In one embodiment, each strap 38 is a 1″ wide, 10′ long high-density nylon strap.

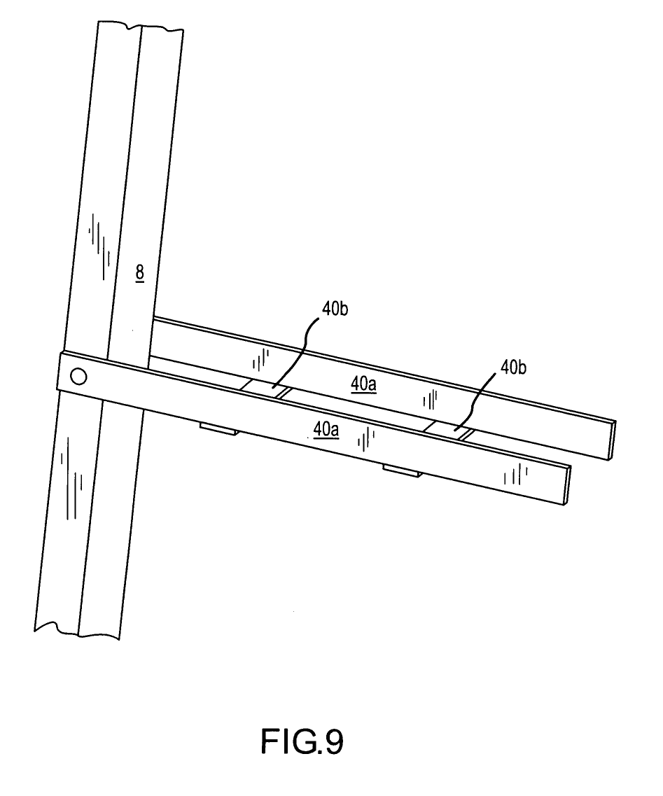

As shown in FIG. 8a, the pivotal member 40 is pivotally attached to leg segment 8b to be near the midpoint of the leg 8. As illustrated in FIG. 9, which is an enlarged isometric view of the pivotal member 40 in the extended position (i.e., the pivotal member 40 is generally perpendicular to its leg 8), the pivotal member 40 has two sidepieces 40a and two cross pieces 40b that form a channel. As indicated by the hidden lines in FIG. 8a, when the pivotal member 40 is in its fully stored position, the leg 8 resides within the channel of the pivotal member 40 and the side pieces 40a and the cross pieces 40b are flush against the sides of the leg 8.

As shown in FIG. 8a, when the hooks 42 are attached to the upper and lower most hook receiving structures 43 and the slack has been removed from the strap 38 via the tightening buckles 44, the pivotal member 40 may be pivoted out to the fully extended position to create a truss-like configuration between the strap 38, the leg 8 and the pivotal member 40. This arrangement substantially stiffens the leg 8 and allows the leg 8 to support a load that would otherwise cause it to buckle.

In some embodiments the strap 38 is employed to create the truss-like leg arrangement regardless of the number of leg segments 8a, 8b, 8c, 8d utilized to create the legs 8. In other embodiments, the leg segments 8a, 8b, 8c, 8d are sufficiently strong such that if the leg 8 is two or less leg segments long (e.g., the leg 8 has only two leg segments 8a, 8b and the bottom leg segment is 8b), the strap 38 is not needed. However, if the leg 8 has more than two leg segments (e.g., three or four leg segments 8a, 8b, 8c, 8d) then the strap is employed to create the truss-like arrangement and to strengthen the legs 8.

For a discussion of another embodiment of the truss-like leg arrangement, reference is now made to FIGS. 8b-8c. FIG. 8b is a side elevation view of a truss-type structural arrangement similar to the one depicted in FIG. 8a, except the arrangement employs a cable 38. FIG. 8c is an isometric view of the free end of the pivotal member 40 employing a pulley 40c for engaging the cable 38 shown in FIG. 8c.

As indicated in FIG. 8b, in one embodiment, the strap 38 depicted in FIG. 8a is replaced with a cable 38. In one embodiment, the cables are ⅛″ diameter aircraft cables.

As can be understood from FIG. 8b, the pivotal member 40 has a locking feature wherein the pivotal member 40 may be pivoted from a non-deployed position (as shown in FIG. 8a by the hidden lines where the pivotal member 40 is against the leg segment 8b) to a locked deployed position (as shown in FIG. 8b) wherein the angle α between the non-deployed position and the locked deployed position is obtuse. An abutment 41 at the pivotal connection between the pivotal member 40 and the leg segment 8b prevents the angle α from becoming more obtuse. Thus, when the pivotal member 40 is in the locked deployed position and the free end of the pivotal member 40 is engaged by the cable 38, the pivotal member 40 is locked in place and prevented from pivoting upwards or downwards.

As shown in FIG. 8c, in one embodiment, the free end of the pivotal member 40 includes a grooved wheel 45 for receiving the cable 38 when the pivotal member 40 is in the deployed position.

For a discussion of a leg height adjustment feature, reference is now made to FIG. 8d, which is an isometric view of the leg height adjustment feature. As indicated in FIG. 8d, in one embodiment, each bottom most leg segment 8d includes an extension feature 47 that allows each leg 8 to be independently adjusted for length. This feature enables the stand 2 to be leveled when erected on an uneven surface.

In one embodiment, the extension feature 47 includes an inner leg member 49 that telescopically extends from within the bottom most leg segment 8d. The inner leg segment 49 includes a plurality of pin holes 51 evenly distributed along the length of the inner leg segment 49 for receiving a pin 53 therein and adjustably positioning the inner leg segment 49 within the bottom most leg segment 8d.

In one embodiment, the bottom end of each inner leg segment 49 includes a pad plate 55. The plate 55 provides a wide supporting footprint for each leg 8 and prevents the leg 8 from sinking into a soft supporting surface.

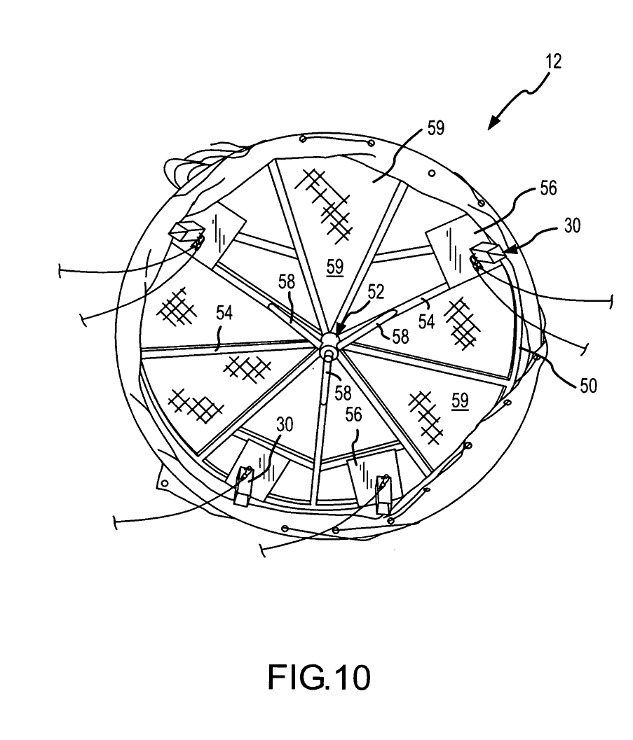

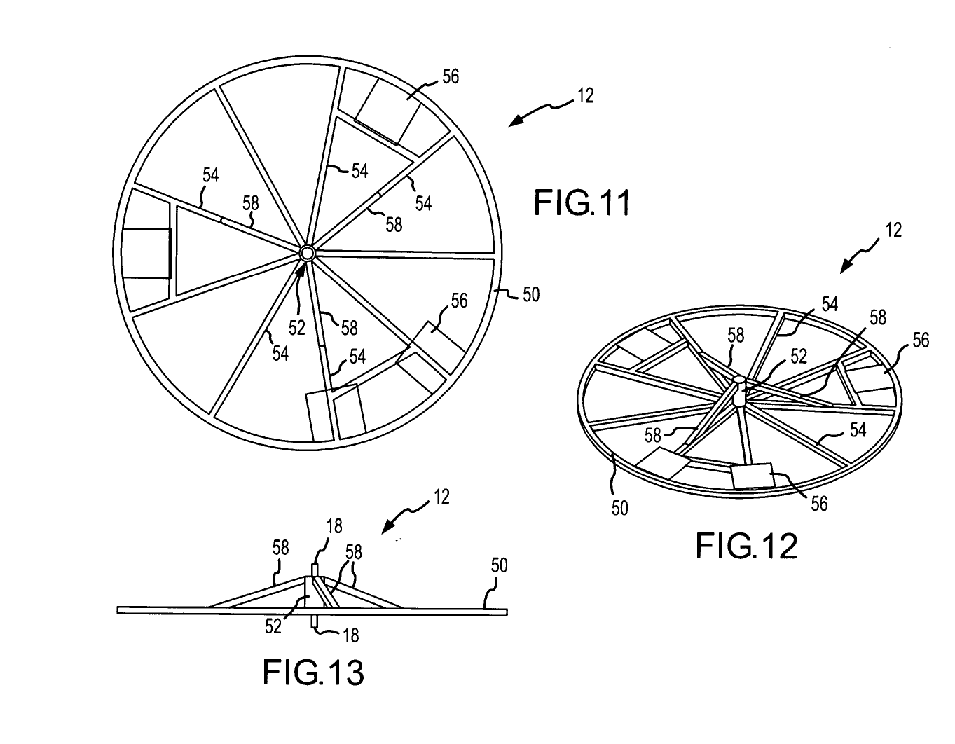

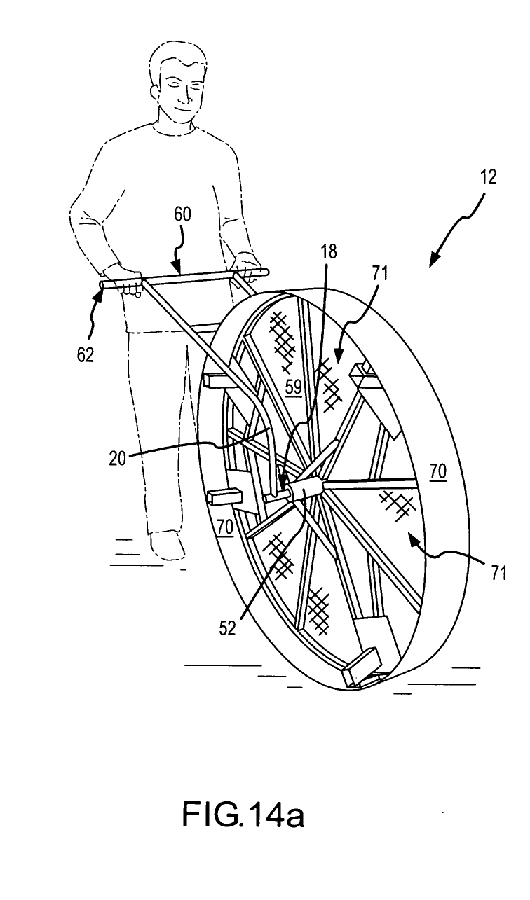

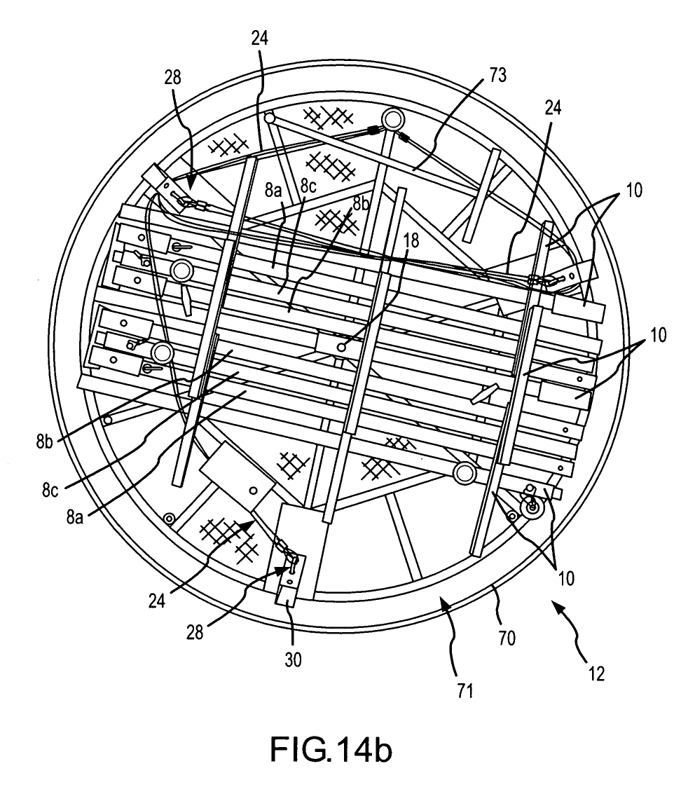

For a detailed description of the round platform and its features, reference is now made to FIGS. 10, 11, 12, 13, 14a and 14b. FIG. 10 is a bottom view of the platform 12 with the fabric sidewall 14 secured to the circumference of the platform. FIG. 11 is a bottom view of the platform 12 illustrating its structural arrangement. FIG. 12 is an isometric view of the platform 12 illustrating its structural arrangement. FIG. 13 is a side elevation view of the platform 12 illustrating is structural arrangement. FIG. 14a is a bottom side view of the platform 12 is its transportation configuration and illustrating its ability to be moved by a single person. FIG. 14b is a bottom side view of the platform 12 showing one means of securing the leg segments 8a, 8b, 8c and cables 24 of the base 6 within volume 71 of the platform 12.

As indicated in FIGS. 10-14b, the round platform 12 has a circular outer circumferential structural rim 50 joined to a center hub 52 by a plurality of structural spokes 54. Additional structural bracing runs between the spokes 54 and adjacent spokes 54 or the structural rim 50 to provide anchor spots for base plates 56. A coupler 30 for receiving a leg segment 8a is secured to each base plate 56 (an enlarged view of the coupler and base plate arrangement is provided in FIG. 6 and discussed above). Hub braces 58 extend from the base of the hub 52 to a point midway along the length of some or all of the spokes 54. A flooring 59 of ½″ expanded diamond steel mesh is attached to the rim 50 and spokes 54.

In one embodiment, the rim 50, spokes 54, hub braces 58, hub 52 and flooring 59 are welded to each other. In other embodiments, these structural aspects of the platform 12 are secured to each other with standard mechanical fasteners as are well known in the art. In one embodiment, the structural rim is 40″ in diameter and is made of ¾″, 18 gage square steel tubing, the hub 52 is 1⅞″, 11 gage round steel tubing and is 4″ in length, and the base plates 56 are 5″ square, 3/32″ thick steel plates

As shown in FIGS. 10, 13 and 14a, the hub 52 is equipped with an axle 18 that is coaxial to the hub 52. In one embodiment, the axle 18 comprises a 7″ long by ¾″ diameter shaft with ¾″ by 1⅝″ sealed bearings pressed on.

As indicated in FIGS. 10, 13 and 14a, the axle 18 extends from both ends of the hub 52 and is adapted to connect to the handle 20. In one embodiment, ⅜″ diameter drilled and tapped holes were added to the ends of the shaft to hold the handle 20 onto the axle 18.

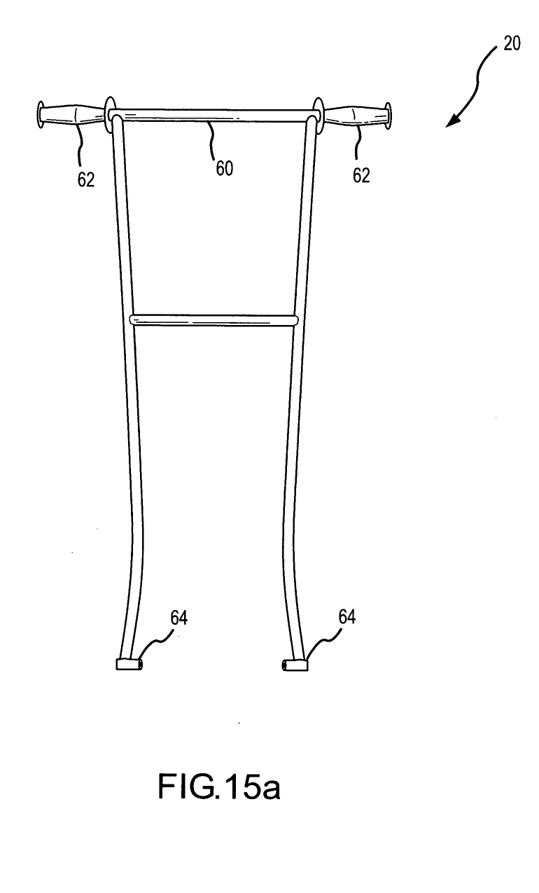

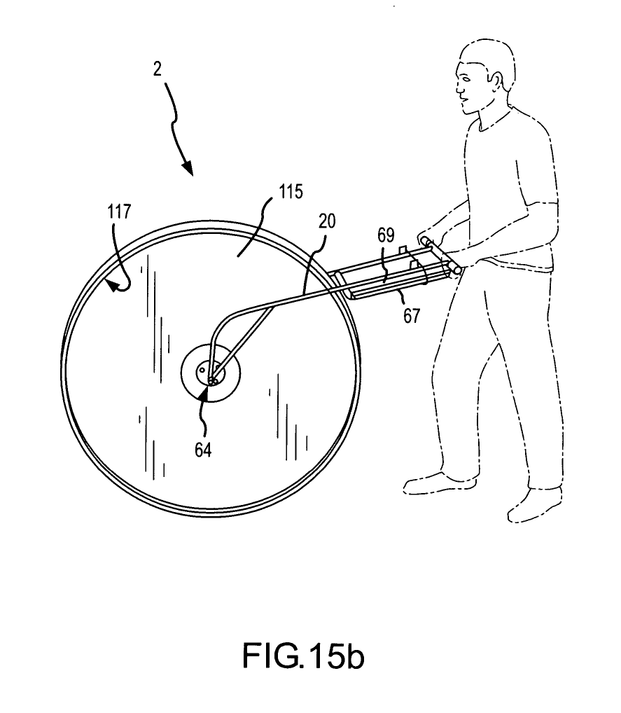

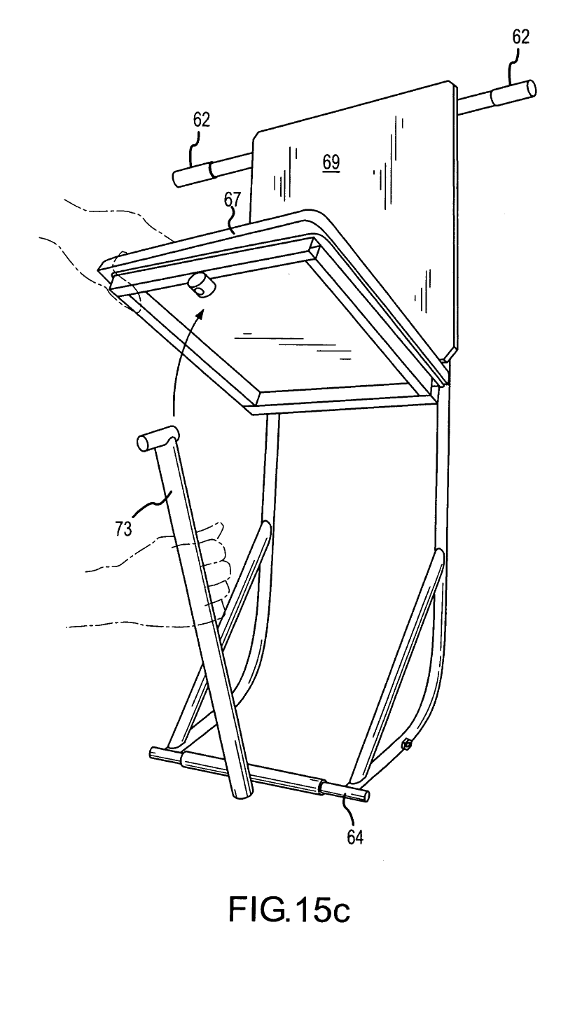

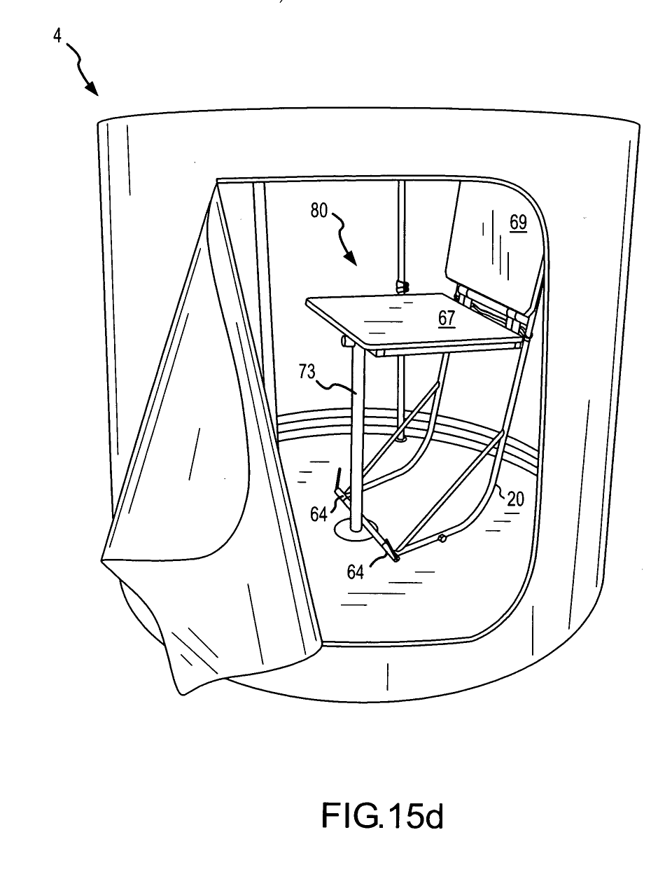

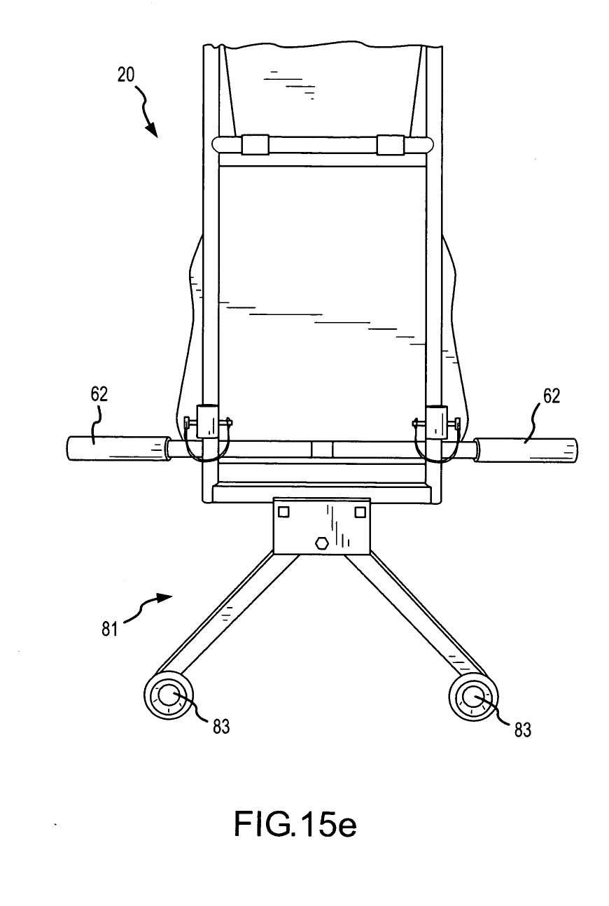

As indicated in FIG. 15a, which is plan a view one embodiment of the handle 20, the handle 20 has a handle bar 60 with handgrips 62 and attaching means 64 for attaching to the ends of the axle 18. Thus, as illustrated in FIG. 3c, a person may grip the handgrips 62 and roll the platform 12 along. Thus, when the stand 2 is in the transportation configuration with the leg and ladder segments and other parts of the stand 2 stored within the platform 12 (see FIG. 3b), a person may roll the stand 2 along as depicted in FIG. 3c. Also, as indicted in FIG. 3a, the handle bar 60 may be attached to a vehicle (e.g., snowmobile 22, ATV, SUV, etc.) to roll the stand 2 along when the stand 2 is in the transportation configuration.

As illustrated in FIG. 14b, the leg segments 8a, 8b, 8c, the ladder segments 10, the cables 24, and the seat pivot axle 73 may all be securing stored within the volume 71 of the platform 12. In one embodiment, the leg segments 8a, 8b, 8c are laid side-by-side between two ladder segments 10, the rungs of the ladder segments 10 extending across the tops of the leg segments to hold said leg segments down. A third ladder segment 10 is located such that its rungs abut against the top surfaces of the rungs of the other two ladder segments 10. A wing bolt 200 is used to hold the third ladder segment down and, as a result, the other ladder and leg segments.

Each cable 24 extends from its point of connection 28 with its respective leg coupler 30, about the other two leg couplers 30, to meet with the free ends of the other to cables 24 to be secured in place via a bolt 202. The seat axle 73 is held in place within the volume 71.

As shown in FIG. 15b, which is side view of another embodiment of the handle 20 connected to the stand 2 in its transportation configuration, the handle 20 includes a seat portion 67 and a back portion 69 for forming a chair 80 that can be pivotally mounted within the perch 4, as discussed later in this Detailed Description.

As illustrated in FIG. 15c, once the handle 20 is removed from the stand 2, the seat portion 67 is pivoted away from the back portion 69 and a chair pivot axel 73 is installed between the bottom of the seat portion 67 and the portions of the handle 64 that attach to the axle 18 of the stand 2. Once handles 62 have been removed and the chair 80 has been fully assembled and pivotally installed within the perch 4, the chair 80 will appear as shown in FIG. 15d.

As shown in FIG. 15e, in one embodiment, the handle 20 has a hitch 81 pivotally attached to the handle 20. In one embodiment, the hitch 81 is configured to attach to an ATV, such as a four-wheeler. In another embodiment, the hitch 81 is configured to attach to a snowmobile. In one embodiment, the hitch 81 includes tension knobs 83 for tightening the attachment between the ATV or snowmobile.

As shown in FIG. 14a, the platform 12 has a wide rim 70 secured to the structural rim 50. The wide rim 70, in one embodiment, is a 6″ wide piece of 20-gage sheet metal welded to the structural rim 50. As illustrated in FIG. 3b, a tread 72 is attached to the outer circumference of the wide rim 70. In one embodiment, the tread 72 is an 8″ wide, ¼″ thick strip of ultra high molecular weight plastic. The substantial width of the wide rim 70 and tread 72 helps to prevent the stand 2 from excessively sinking into soft surfaces (e.g., snow, mud, sand, leaves, etc.) when the stand 2 is being rolled along. Also, the width of the wide rim 70 and the tread 72 helps to maintain the stand 2 in its upright rolling orientation when the stand 2 is being rolled along. Finally, the wide rim 70 and the flooring 59 form boundaries for a volume 71 in which the parts 6, 16 of the stand 16 may be held when the stand 2 is in the transportation configuration as depicted in FIG. 3b.

In one embodiment, the structural features of the platform 12 are formed from steel, aluminum or another metal. In another embodiment, the platform 12, including the rim 70, center hub 52, flooring 59, etc., are formed or molded as an integral unit from a polymer material.

The substantial diameter of the platform structure 12, which in one embodiment is 40″, results in a large wheel 12. The large diameter of the wheel 12, the substantial width of the tread 72, and the lightweight construction of the parts 6, 16 contained within the wheel 12 when the stand 2 is in the transportation configuration as (see FIG. 3b) results in a highly maneuverable configuration. For example, as illustrated in FIG. 3c, a single person may easily roll the wheel 12 (i.e., the stand 2 in the transportation configuration) over an obstacle, such as a log 100.

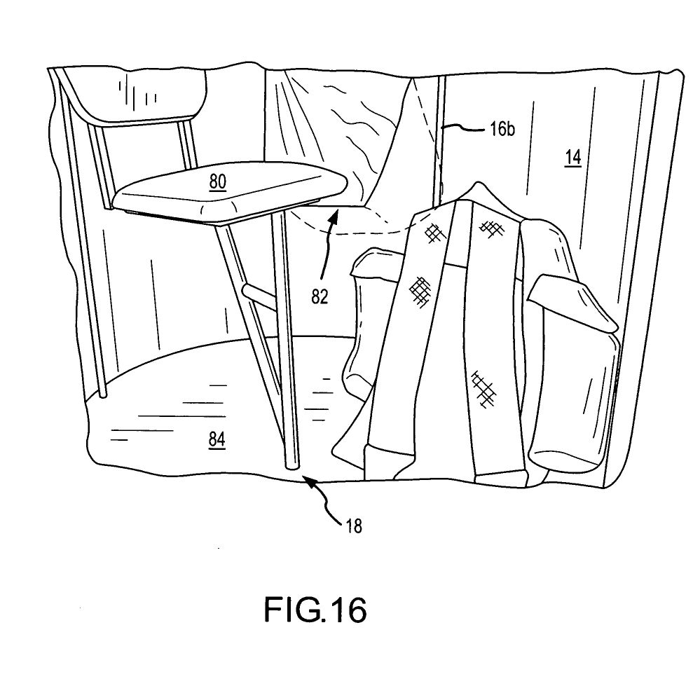

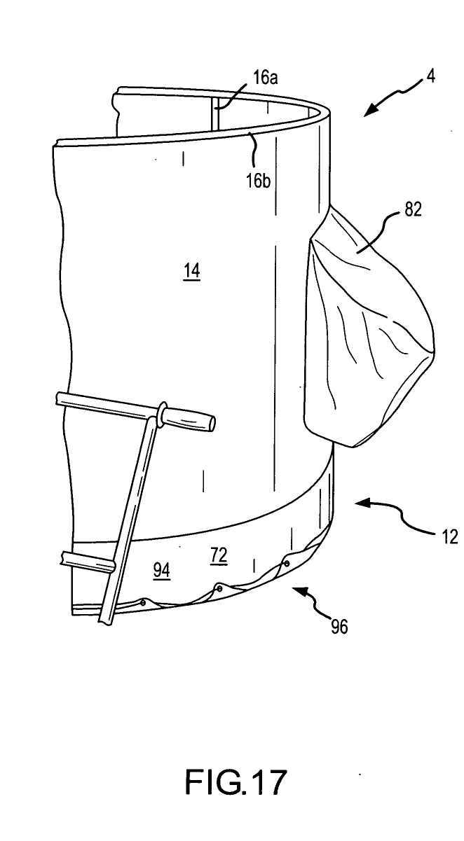

For a detailed description of the features within the perch 4, reference is now made to FIGS. 16 and 17. FIG. 16 is view of a chair 80 and an opening of a pouch 82 within the perch 4. FIG. 17 is view of the pouch 82 from outside of the perch.

As shown in FIG. 16, outdoor carpet 84 covers the flooring 59 of the platform 12. The chair 80 is pivotally mounted on the axle 18. The vertical members 16a support the fabric sidewall 14 and the opening of the pouch 82 is defined in the sidewall 14 of the perch 4.

As best understood from FIG. 17, the pouch 82 is exterior to the perch 4 and, in one embodiment, is sized large enough to receive a standard hiking backpack. Thus, the pouch 82 helps to provide more free space within the perch 4 for the occupant because the occupant's backpack is held exterior to the perch 4.

As indicated in FIG. 17, the fabric of the sidewall 14 extends down from the sidewall 14 and over the tread 72 to form a flap 94 with a drawstring 96. As indicated in FIG. 3b, when the stand 2 is in the transportation configuration with the parts 6, 16 of the stand 2 stored within the round platform 12, the flap 94 is pulled over the side of the platform 12 containing the parts 6, 16 and drawn tight via the drawstring 96. Besides sheet metal straps, bungee cords, bags or other securing means that may be used to maintain the parts 6, 16 within the round platform 12 when in the transportation configuration, the flap 94 helps to maintain the parts within the platform 12 too.

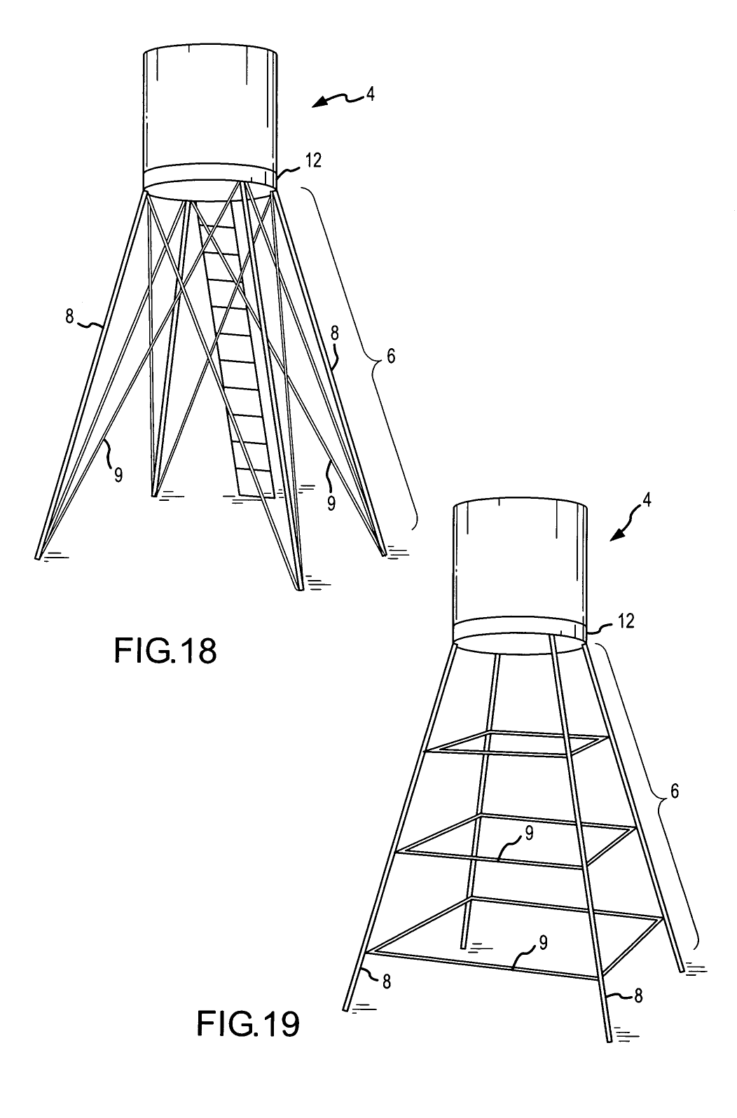

While in one embodiment the stand 2 employs a base 6 comprising truss-type legs 8 as depicted in FIG. 8, other embodiments may employ bases 6 with other types of leg 8 arrangements. For example, FIGS. 18 and 19 depict the stand 2 employing a base 6 with a standard scaffold-type bracing arrangement, as is common in the art. The bases 6 of FIGS. 18 and 19 employ legs 8 that are maintained in position via rigid cross-bracing members 9. The legs 8 and cross-bracing members 9 are segmented and may be dismantled and stored within the volume 71 of the platform 12 when the stand 2 is transformed into its transportation configuration.

In one embodiment, as depicted in FIG. 15b, the volume 71 is covered by a separate protective cover 115 that has an outer edge that is received within a C channel 117 that extends along the inner circumference of the volume 71. The outer edge of the cover 115 includes a drawstring. The protective cover serves to hold the components of the stand 2 within the volume 71 and protects against water, snow, dirt and debris from entering into the volume 71 when the stand 2 is being transported.

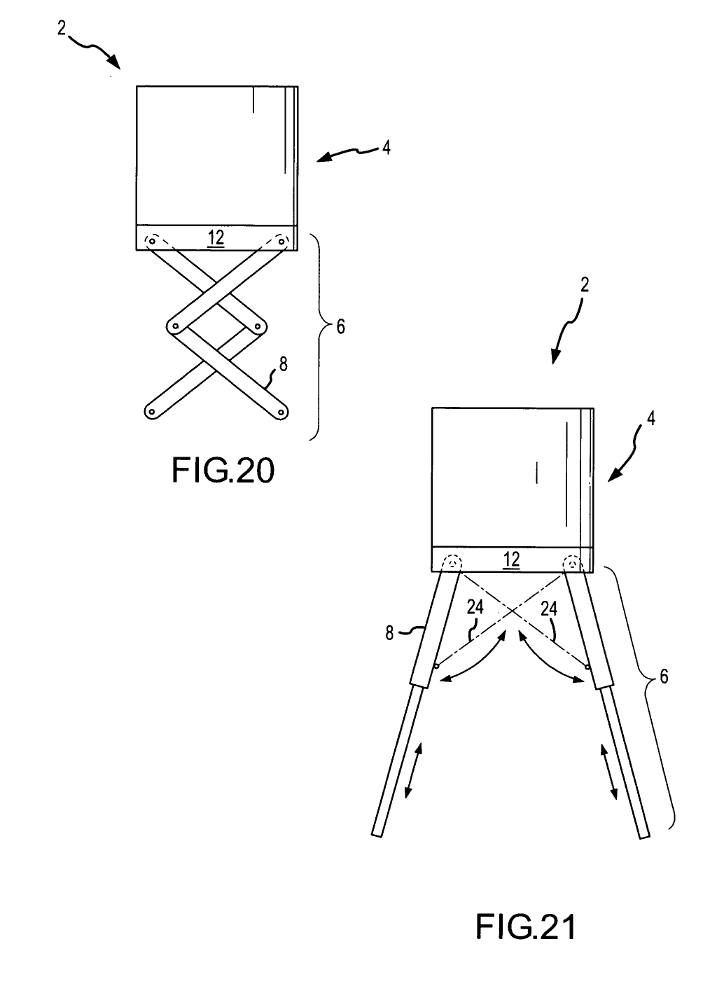

In another embodiment, as indicated in FIG. 20, the stand 2 employs a base 6 having a scissor-type leg 8 arrangement that extends the base 6 from the volume 71 of the platform 12 when the stand is deployed and retracts the base 6 back into the volume 71 when the stand is transformed into its transportation configuration. In another embodiment, as illustrated in FIG. 21, the stand 2 employs a base 6 having legs 8 that are deployed by pivoting outwardly from within the volume 71 and then extending via a telescoping feature.

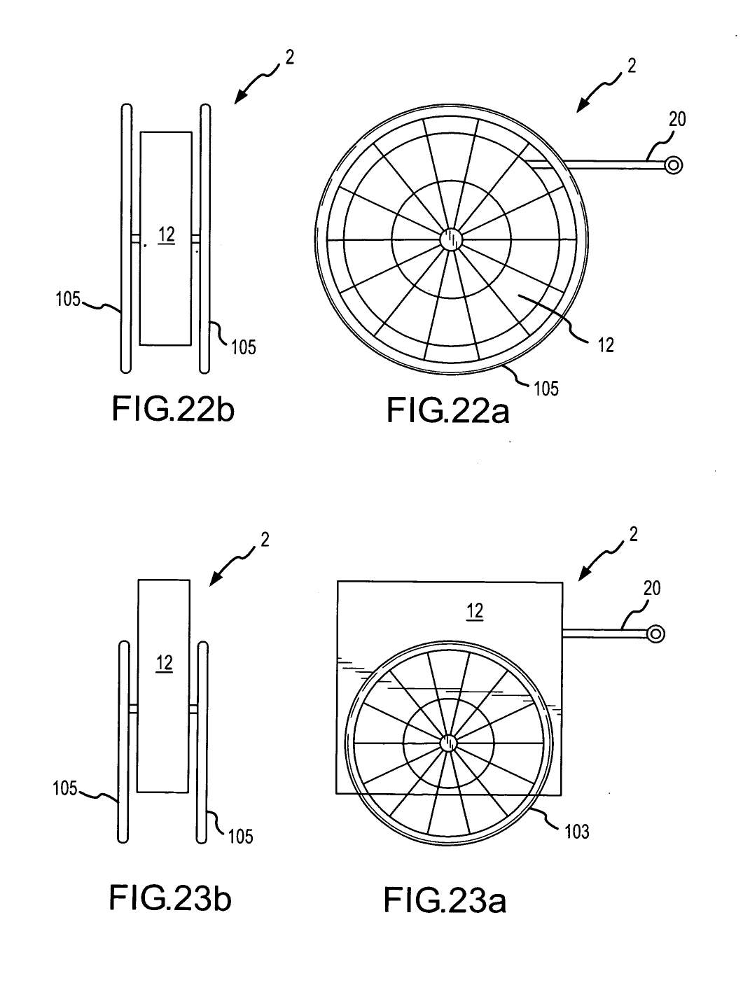

While FIGS. 3a, 3b and 3c depict the platform 12 serving as the wheel to rollably move the stand 2 when it is in the transportation configuration, in other embodiments, as depicted in FIGS. 22a, 22b, 23a and 23b, the stand 2 may be rolled on actual wheels 105 that are attached to the platform 12, which still serves as the volume 71 in which the stand parts are enclosed. FIGS. 22a and 22b are a side elevation and a front elevation, respectively, of the stand 2 having a round platform 12 and in the transportation configuration. Similarly, FIGS. 23a and 23b are a side elevation and a front elevation, respectively, of the stand 2 having a rectangular platform 12 and in the transportation configuration.

As illustrated in FIGS. 22a, 22b, 23a and 23b, wheels 105 are pivotably attached to the platform 12. The parts making up the stand's base 6 and perch 4 are stored within the volume 71 of the stand 12, as previously explained. A handle 20 is attached to the stand 2 for rolling the stand 2 along while in the transportation configuration.

A method of utilizing the stand 2 in the field will now be narrated by referring to FIGS. 1, 3a, 3b, 3c, 4a, 6, 7, 14a, 14b, 16 and 17. Beginning the narration with the stand 2 already in the transportation configuration as shown in FIG. 3b, the person attaches one end of the handle 20 to the axle 18 and the other end to a vehicle, such as a snowmobile 22 as shown in FIG. 3a. Alternatively, the person may simply grab the grips 62 of the handle 20 as depicted in FIG. 3c. Either way, the stand 2 may then be rolled along its tread 72 to the setup location.

As depicted in FIG. 3b, the parts for the stand 2 (i.e., the sidewall fabric, the parts for the base 6, the parts the sidewall frame 16, the chair 80, etc.) are held within the volume 71 (see FIGS. 14a and 14b) formed by the wide rim 70 and the flooring 59. To remove the parts 6, 16, the handle 20 is disconnected from the axle 18 and the round platform 12 is laid on the ground with its flooring 59 down and the volume 71 facing upward. The drawstring 96 is loosened and the flap 94 is pulled back over the tread 72 (as depicted in FIG. 17) to reveal the stand parts 6, 16 held within the volume 71. All of the parts 6, 16 are pulled out of the volume 71 and laid aside for assembly.

The hoop 16b is gripped and pulled upwards out of the volume 71 to extend the fabric sidewall 14 upward as shown in FIG. 17. The vertical members 16a are inserted into place to support the hoop 16b and, as a result, the sidewall 14 (as depicted in FIGS. 16 and 17). The chair 80 is pivotally mounted on the axle 18 (see FIG. 17).

The side of the platform 12 adapted to receive the non-ladder legs 8 is lifted and non-ladder leg segments 8a are inserted into the couplers 30 at the bottom of the platform 12 (see FIGS. 4a, 6 and 8). The side of the platform 12 adapted to receive the ladder legs 8 is then lifted and the ladder portions 8a are inserted into the couplers 30 a the bottom of the platform 12. The wing nuts 32 are tightened to secure the leg segments 8a in place within the couplers 30.

The side of the platform 12 adapted to receive the non-ladder legs 8 is lifted again and non-ladder leg segments 8b are inserted into the couplers 30 at the bottom of leg segments 8a (see FIGS. 4a and 8). The side of the platform 12 adapted to receive the ladder legs 8 is then lifted and the ladder portions 8b are inserted into the couplers 30 at the bottom of leg segments 8a. The wing nuts 32 are tightened to secure the leg segments 8b in place within the couplers 30. The bottom ends of the cables 24 running from the platform/cable connection points 28 to the leg/connection points 26 are then attached to the pins 36 as shown in FIG. 7.

The side of the platform 12 adapted to receive the non-ladder legs 8 is lifted again and non-ladder leg segments 8c are inserted into the couplers 30 at the bottom of leg segments 8b (see FIGS. 4a and 8). The side of the platform 12 adapted to receive the ladder legs 8 is then lifted and the ladder portions 8c are inserted into the couplers 30 at the bottom of leg segments 8b. The wing nuts 32 are tightened to secure the leg segments 8c in place within the couplers 30.

The side of the platform 12 adapted to receive the non-ladder legs 8 is lifted again and non-ladder leg segments 8d are inserted into the couplers 30 at the bottom of leg segments 8c (see FIGS. 4a and 8). The side of the platform 12 adapted to receive the ladder legs 8 is then lifted and the ladder portions 8d are inserted into the couplers 30 at the bottom of leg segments 8c. The wing nuts 32 are tightened to secure the leg segments 8d in place within the couplers 30.

The legs 8 are spread apart from each other at their bottoms as far as the cables 24 will allow. A strap 38 is then provided for each leg 8. Specifically, for each leg, a top strap hook 42 is inserted into the uppermost hook receiving structure 43 (i.e., the structure 43 on the leg segment 8a) and a bottom strap hook 42 is inserted into the lowermost hook receiving structure 43 (which in this case is the structure 43 on the leg segment 8d). The slack is then removed from the strap 38 via the buckles 44. The truss-like configuration for each leg 8 is then created by extending the pivot member 40 outward to a position generally perpendicular to each leg 8. This places the strap 38 into tension and helps to stiffen the legs, thereby allowing them to carry more vertical load than they would without the truss-like arrangement.

To dismantle the stand 2 and convert it to the transportation configuration, the above-described process is reversed.

It should be noted that in one embodiment, a pair of false legs are inserted into the non-ladder leg segments prior to lifting the ladder side of the structure to insert the ladder leg segments. The false legs are then removed and another set of non-ladder leg segments are inserted, after which the false legs are inserted into the newly inserted non-ladder leg segments. The ladder side of the structure is again lifted to insert the ladder leg segments. The process is then repeated until the desired number of leg segments has been added to the base supporting the perch.

Although the present invention has been described with reference to preferred embodiments, persons skilled in the art will recognize that changes may be made in form and detail without departing from the spirit and scope of the invention.

1. A wildlife observation stand comprising:
a perch comprising a platform including a circular outer circumference; and
a base adapted to support the perch when the stand is in an erected state,
wherein the platform is configured to be rollably displaceable while supporting at least one element of the stand when the stand is in a non-erected state.

2. The stand of claim 1, wherein the circular outer circumference defines a volume and the at least one element is supported within the volume.

3. The stand of claim 1, further comprising an axle centered in the platform and about which the platform pivots when being rollably displaced.

4. The stand of claim 3, further comprising a handle adapted to connect to the axle.

5. The stand of claim 4, wherein the handle converts to a seat pivotably coupled to the platform when the stand is in an erected state.

6. The stand of claim 1, wherein the perch further comprises a sidewall.

7. The stand of claim 6, wherein the at least one element includes a structural element of the sidewall.

8. The stand of claim 1, wherein the at least one element includes a structural element of the base.

9. A wildlife observation stand comprising a platform and a base adapted to support the platform, wherein the stand is rollably displaceable in a non-erected state.

10. The stand of claim 9, wherein the platform comprises an axle for rollable displacement of the stand.

11. The stand of claim 10, further comprising a handle pivotably coupled to the axle.

12. The stand of claim 11, wherein the platform further comprises a volume for holding elements of the stand when the stand rollably displaces.

13. The stand of claim 12, wherein said elements includes portions of the base.

14. The stand of claim 11, wherein the handle is configured to become a seat coupled to the platform.

15. The stand of claim 10, further comprising a wheel pivotably coupled to the stand.

16. The stand of claim 15, wherein the platform further comprises a volume for holding elements of the stand when the stand rollably displaces.

17. The stand of claim 16, wherein said elements includes portions of the base.

18. A base system for supporting the perch of a wildlife observation stand above a surface, the base comprising:
a leg including a first end adapted for connection to the perch, a second end adapted to abut against the surface, and a member having a free end opposite a pivot end pivotally attached to the leg between the first and second ends; and
a cable-like element including a first end operably coupled to the leg near the first end and a second end operably coupled to the leg near the second end.

19. The base system of claim 18, wherein the cable-like element and leg form a truss-like arrangement when the member is pivoted into a position where the member is not parallel to the leg and the free end engages the cable-like element.

20. The base system of claim 19, wherein the cable-like element is a cable.

21. The base system of claim 20, wherein the member includes a pulley at the free end for receiving the cable.

22. The base system of claim 19, wherein the cable-like element is a strap.

23. A method of transporting a wildlife observation stand, the method comprising storing at least one element of the stand within a stand platform and rollably displacing the platform along a surface.

24. The method of claim 23, wherein the stand platform comprises an axle pivotably coupled to a handle.

25. The method of claim 23, wherein the stand platform comprises an axle pivotably coupled to a wheel.
